(19) United States
(12) Patent Application Publication
(10) Pub. No.: US 2014/0160497 A1
(43) Pub. Date: Jun. 12, 2014

(54) PRINTER IMAGE ALIGNMENT

(71) Applicant: HEWLETT-PACKARD DEVELOPMENT COMPANY, L.P., Houston, TX (US)

(72) Inventors: Robert J. Lawton, Meridian, ID (US); Brian T. Bartlow, Boise, ID (US)

(73) Assignee: Hewlett-Packard Development Company, L.P., Houston, TX (US)

(21) Appl. No.: 13/712,013

(22) Filed: Dec. 12, 2012

(51) Int. Cl. H04N 1/00

(52) U.S. Cl. CPC H04N 1/00015
USPC 358/1.9

(57) ABSTRACT

A printer calibration method is disclosed. A printer prints a first target on a page. The page is rotated 180 degrees and reloaded into the printer. The printer prints a second target onto the same side of the page. The two targets produce information on image alignment to the page.

### BACKGROUND

Accurately positioning an image on media in a printer typically requires some type of calibration. Many calibration procedures require a measurement or scan of some type, typically done by a user of the device. The measurement or scan can introduce inaccuracies in the calibration procedure.

### DESCRIPTION OF THE DRAWINGS

FIG. 1 is a block diagram of an example printer.

FIG. 2 is an example block diagram of the processor coupled to memory.

FIG. 3 is an example image of a target used in the printer calibration.

FIG. 4A-4D are printouts of two images of a target printed on the same side of a sheet of media, rotated by 180 degrees with respect to each other.

FIG. 5 is a flow chart for a calibration procedure for aligning an image to the page.

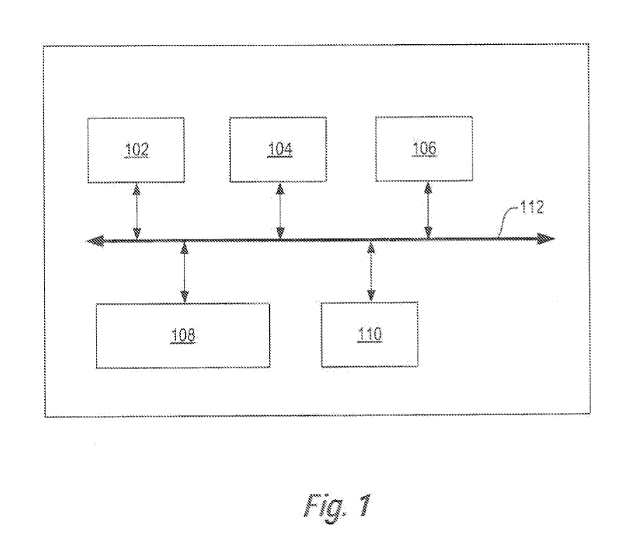

FIG. 1 is a block diagram of an example printer. Printer comprises a processor 102, memory 104, input/output (I/O) module 106, print engine 108 and controller 110 all coupled together on bus 112. In some examples printer may also have a display, a user interface module, an input device, and the like, but these items are not shown for clarity. Processor 102 may comprise a central processing unit (CPU), a micro-processor, an application specific integrated circuit (ASIC), or a combination of these devices. Memory 104 may comprise volatile memory, non-volatile memory, and a storage device. Memory 104 is a non-transitory computer readable medium. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

I/O module 106 is used to couple printer to other devices, for example the Internet or a computer. Print engine 108 may comprise a LaserJet print engine, an inkjet print engine, or the like. Printer has code, typically called firmware, stored in the memory 104. The firmware is stored as computer readable instructions in the non-transitory computer readable medium (i.e. the memory 104). Processor 102 generally retrieves and executes the instructions stored in the non-transitory computer-readable medium to operate the printer, in one example, processor executes code that directs controller 110 to calibrate the printer.

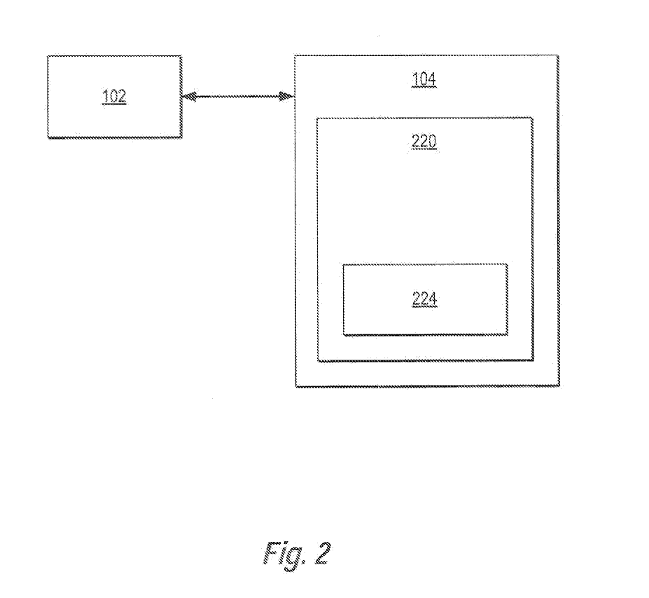

FIG. 2 is an example block diagram of the processor 102 coupled to memory 104. Memory 104 contains firmware 220. Firmware 220 contains a calibration module 224. The processor 102 executes the code in calibration module 224 to direct controller 110 to calibrate the printer. Printer calibration may comprise adjusting the color or tone of an image as well as aligning the image onto the page. In this example the alignment of the image with respect to the page will be discussed.

In one example, the printer calibration module causes the printer to print an image of a target onto one side of the media. The media is rotated 180 degrees and reinserted into the printer such that the same side of the page will be printed on (i.e. the page is not flipped over). The print calibration module then prints the image of the target onto the same side of the page on top of the first image of the target. The second image of the target will be rotated 180 degrees with respect to the first image of the target. The two images of the target overlap and the overlapping images create visual indications of the offset between the two images. The visual indications of the offset between the two images can be entered into the printer to align the printed images to the page. In one example, the image of the target can be stored in the calibration module. In other examples, the image of the target may be downloaded into the printer from an external source like the Internet.

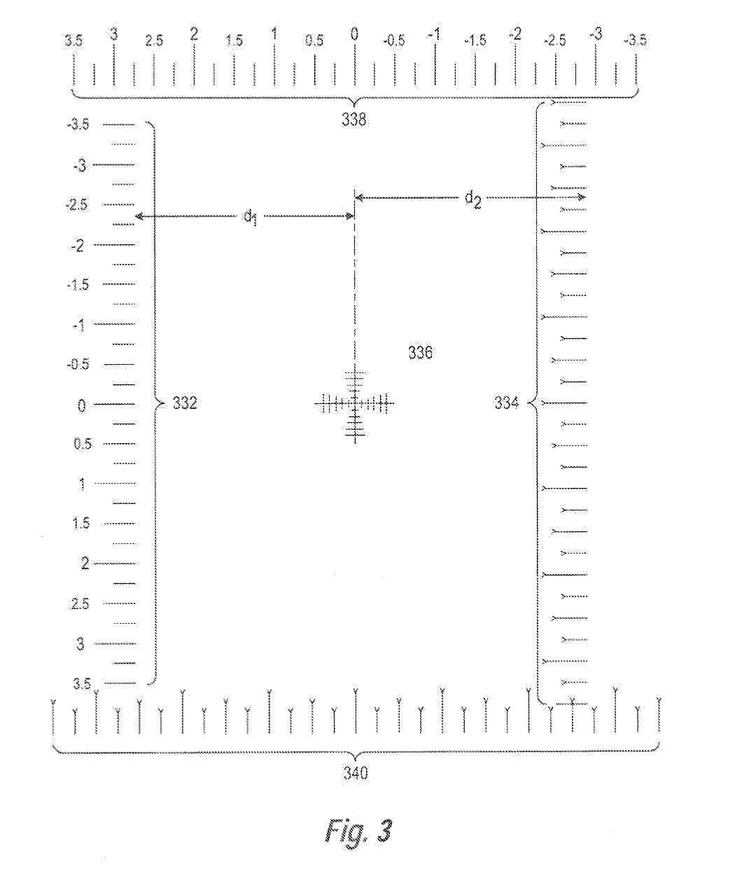

FIG. 3 is an example image of a target used in the printer calibration. The target has an X-axis data scale 338, an X-axis vernier scale 340, a Y-axis data scale 332, a Y-axis vernier scale 334, and a center pattern 336. The inside edge of the Y-axis data scale 332 is located at distance d1 from the center of the target image. The outside edge of the Y-axis vernier scale 334 is located at distance d2 from the center of the target image. In one example, distance d1 may be slightly less than distance d2. In other examples d1 and d2 may be equal or d1 may be slightly more than d2. Slightly is equal to about half an inch or less. When the two targets are within half an inch of each other or overlap each other by half an inch or less, the two targets will be considered “near” each other. The inside edge of the X-axis data scale 338 and the outside edge of the X-axis vernier scale 340 are located at a similar distances from the target center.

A vernier scale is scale which allows a distance measurement to be read more accurately than directly reading a uniformly-divided straight measurement scale. It is a secondary scale that is used to indicate where the measurement lies when it is in between two of the marks on a main or data scale. Direct verniers are when the indicating scale is constructed so that when its zero point is coincident with the start of the data scale, its graduations are at a slightly smaller spacing than those on the data scale and so none but the last graduation coincide with any graduations on the data scale. N graduations of the indicating scale would cover N−1 graduations of the data scale. A retrograde vernier is similar to the direct vernier except its graduations are at a slightly larger spacing. N graduations of the indicating scale would cover N+1 graduations of the data scale.

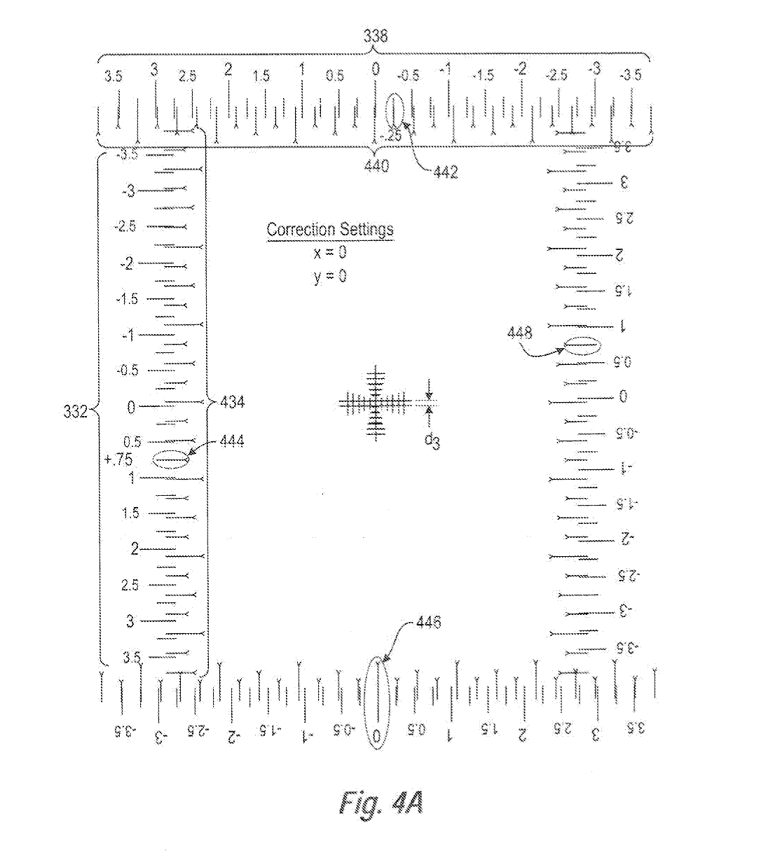

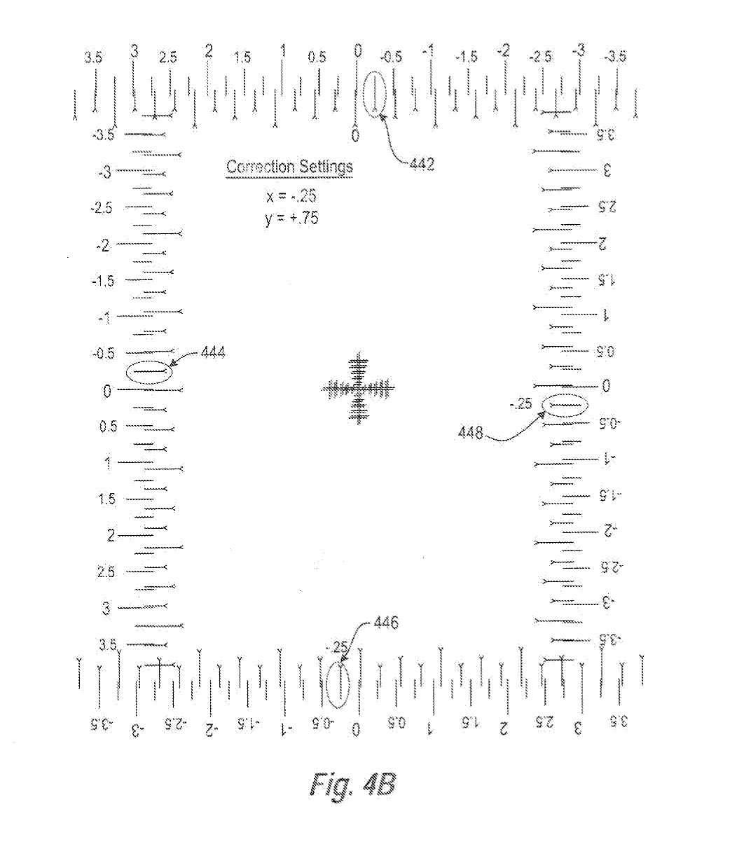

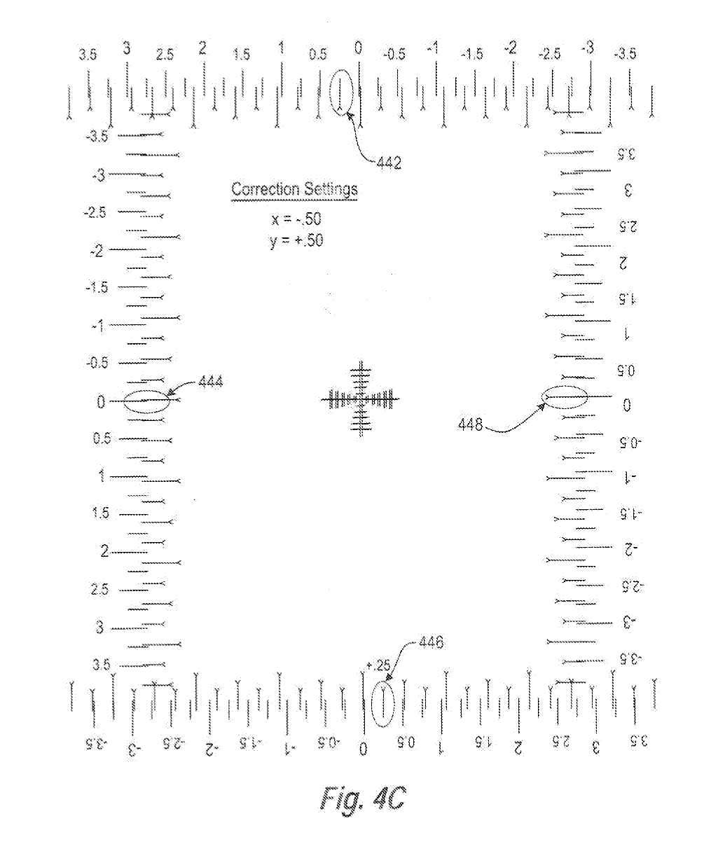

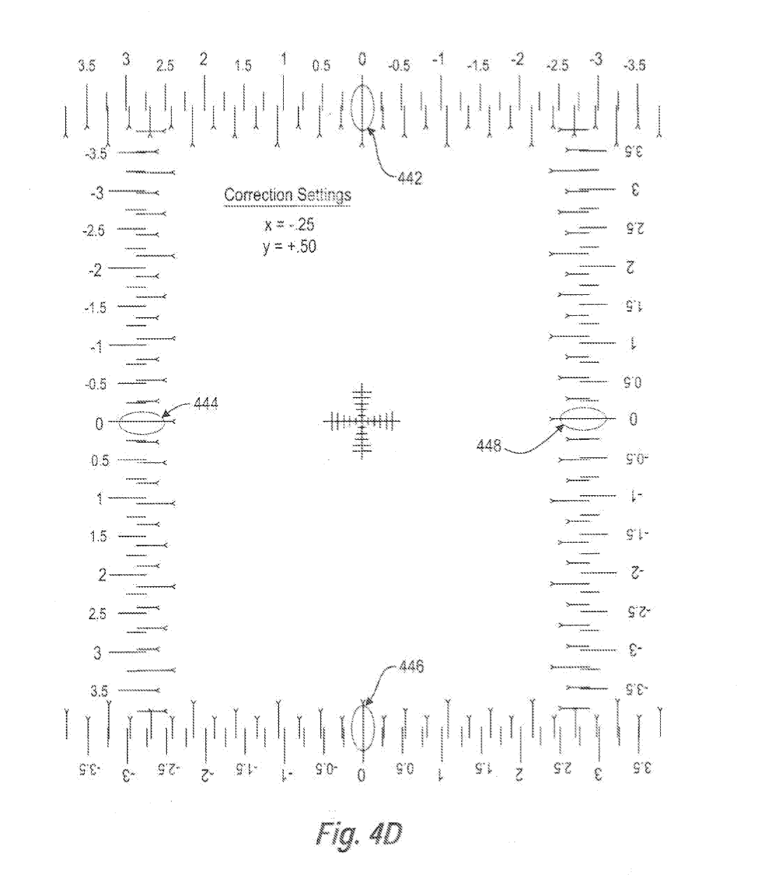

When two images of the target are printed on the same side of a sheet of media, rotated by 180 degrees with respect to each other, the Y-axis data scale of the first image will slightly overlap the Y-axis vernier scale of the second image in the x-direction. The Y-axis vernier scale of the first image will slightly overlap the Y-axis data scale of the second image in the x-direction. That's because distance d1 is slightly less than distance d2. The data scale will overlap the vernier scale by the difference between d1 and d2. In other examples distance d1 and d2 may be equal or distance d1 may be slightly larger than d2. When d1 is equal to d2 the two scales will just touch each other. When d1 is slightly larger than d2 the scale will be printed near each other. When the two targets are within half an inch of each other or overlap each other by half an inch or less, the two targets will be considered “near” each other. The X-axis data and vernier scales of the first and second image will overlap in a similar manner. The central pattern of the two images will completely overlap. When the printer is properly calibrated the two images of the targets will be exactly aligned in both the X and Y axis (see FIG. 4D).

When the printer is out of calibration there will be an offset or miss-alignment between the two images of the target. The offset may be in the X axis, the Y axis, or both the X and Y axis. FIG. 4A is a printout of two images of a target printed on the same side of a sheet of media, rotated by 180 degrees with respect to each other. The two images in FIG. 4 were printed with a zero correction offset for both the X and Y directions. The Y-axis data scale 332 of the first image is located on the left side of the image. The Y-axis vernier scale from the second image 434 is also on the left side of the image and slightly overlaps the Y-axis data scale 332. The X-axis data scale 338 of the first image is located on the top side of the image. The X-axis vernier scale from the second image 440 is also on the top side of the image and slightly overlaps the X-axis data scale 338.

The Y-axis data scale of the second image is located on the right side of the image (shown with the scale upside down). The Y-axis vernier scale from the first image 434 is also on the right side of the image and slightly overlaps the Y-axis data scale from the first image. The X-axis data scale of the second image is located on the bottom side of the image. the X-axis vernier scale from the first image is also on the bottom side of the image and slightly overlaps the X-axis data scale from the second image. The center patterns of the first and second images also overlap in the middle of the image.

The offset or miss-alignment between the two images can be seen using the center target. The two images are offset in both the X and Y directions. The two images are offset by a large distance d3 in the Y direction and by a small amount in the X direction. Using the overlapping data and vernier scales on the sides and the top and bottom of the image, a better measurement of the offsets can be determined. A vernier scale is aligned with the data scale where the two lines in the different scales match or lineup. The human eye can detect whether two line segments are aligned or if they are slightly off alignment. Vernier acuity is the ability by a person to detect the proper alignment of two line segments. In most people, Vernier acuity is particularly high, allowing one to accurately differentiate between aligned and misaligned marks on a Vernier scale.

On the top of FIG. 4A the vernier scale aligns with the data scale at location 442. Using the top scale the miss-alignment is a −0.25 offset. On the bottom of FIG. 4A the vernier scale aligns with the data scale at location 446 with a zero offset or miss-alignment. On the left side of the image the vernier scale aligns with the data scale at location 444 with a +0.75 offset. On the right side of FIG. 4 the vernier scale aligns with the data scale at location 448 yielding a +0.75 offset. Therefore the offset in the X-axis is between zero and −0.25 and the offset in the Y-axis is +0.75. The offset values are relative values. Because the initial offset values were zero the offset values are entered into the printer and the calibration procedure is repeated to confirm the results.

FIG. 4B is printout of two images of a target printed on the same side of a sheet of media, rotated by 180 degrees with respect to each other. the two images in FIG. 4B were printed with a −0.25 X correction offset and a +0.75 Y correction offset. Looking at the center pattern the alignment between the two images is better than the alignment in FIG. 4A. In some examples the calibration procedure may stop at this point. In other examples another iteration or two of the calibration procedure may be performed as there still may be room for improvement.

On the top of FIG. 4B the vernier scale aligns with the data scale at location 442 with an offset between zero and −0.25. On the bottom of FIG. 4B the vernier scale aligns with the data scale at location 446 with a −0.25 offset or miss-alignment. On the left side of FIG. 4B the vernier scale aligns with the data scale at location 444 with a −0.25 offset. On the right side of FIG. 4B the vernier scale aligns with the data scale at location 448 yielding a −0.25 offset. Therefore the offset in the X-axis is between zero and −0.25 and the offset in the Y-axis is −0.25. These are relative offset values, so the new correction values would be −0.50 in the X direction and +0.50 in the Y direction (−0.25+(−0.25)=−0.50 and +0.75+(−0.25)=+0.50). In other examples the numbers may be absolute values that can be entered directly into the printer.

FIG. 4C is a printout of two images of a target printed on the same side of a sheet of media, rotated by 180 degrees with respect to each other. the two images in FIG. 4C were printed with a −0.50 X correction offset and a +0.50 Y direction offset. Looking at the center pattern the alignment between the two images is better than the alignment in FIG. 4A but may not be as good as in FIG. 4B. Therefore one more iteration of the calibration procedure is performed.

On the top of FIG. 4C the vernier scale aligns with the data scale at location 442 with an offset between zero and +0.25. On the bottom of FIG. 4B the vernier scale aligns with the data scale at location 446 with a +0.25 offset or miss-alignment. On the left side of FIG. 4B the vernier scale aligns with the data scale at location 444 with a zero offset. On the right side of FIG. 4B the vernier scale aligns with the data scale at location 448 yielding a zero offset. Therefore the offset in the X-axis is +0.25 and the offset in the Y-axis is zero. These are relative offset values, so the new correction values would be −0.25 in the X direction and +0.50 in the Y direction.

FIG. 4D is printout of two images of a target printed on the same side of a sheet of media, rotated by 180 degrees with respect to each other. The two images in FIG. 4C were printed with a −0.25 X correction offset and a +0.50 Y direction offset. The images are almost exactly aligned. The offsets at the 4 data scales are all zero (locations 442, 444, 446 and 448). Therefore no more improvement in alignment can be gained by repeating the calibration procedure.

The calibration procedure described above uses two images of the same target printed at 180 degrees with respect to each other on the same side of the page. In other examples two different images/targets may be used. For example the first target may only contain an X-axis and a Y-axis data scale and the second target/image may only contain an X-axis vernier scale. When the two images are combined there would be just one reading in each axis.

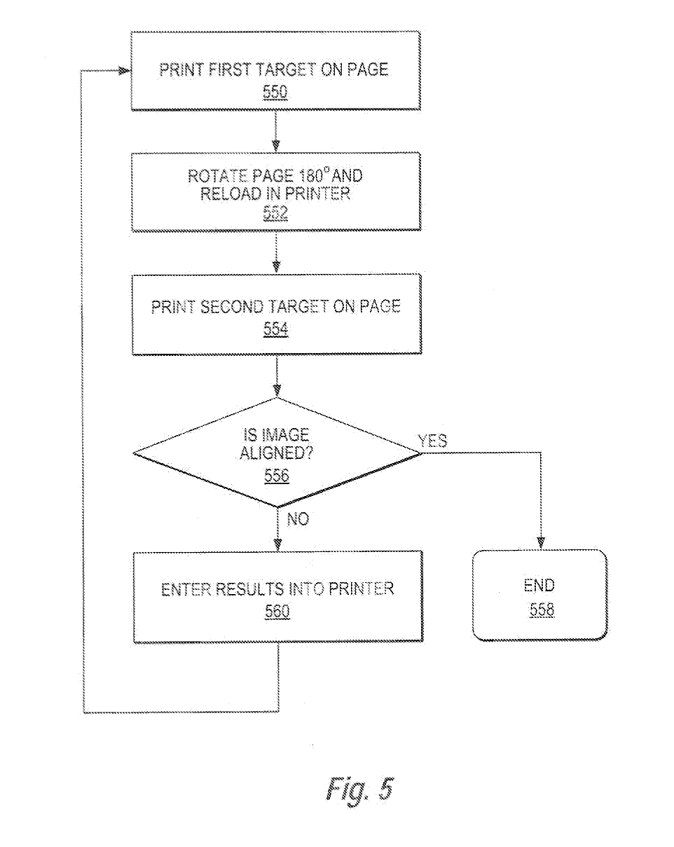

FIG. 5 is a flow chart for a calibration procedure for aligning an image to the page. At step 550 a first image is printed onto a page. At step 552 the page is rotated 180 degrees and re-loaded into the printer. At step 554 a second image is printed onto the same side of the page. At step 556 the images of the two targets are examined to determine if the image is aligned on the page. If the image is aligned flow ends at step 558. When the images are not aligned the correction amounts are determined from the images of the two targets and the results are entered into the printer. Flow then returns to step 550. In some examples the printer will calculate the adjusted offset values using the adjustments to the offsets shown on the target. In this case the user would enter the adjustments to the offsets into the printer. In other examples the target may incorporate the current offset values in the scales. In this example an absolute value will be shown by the two images printed on the media and the user will enter the absolute value into the printer instead of an adjusted value.

In some examples the first and second images used in steps 550 and 554 are the same. In other examples the targets may be different. In some examples, at step 552 the printer may prompt the user to re-feed the page into the printer after rotating the page 180 degrees. Because the print path determines which side of the page needs to be facing up when loaded into the input tray to have a specific side of the page printed on, the printer may also prompt the user to load the page with the first image in a specific orientation. For example, some printers cause an image to be printed on the bottom side of a page loaded into the input tray. In that case the printer would prompt the user to re-load the page at step 552 with the image face down. The printer may also prompt the user to load the page with a specific edge at the top of the input tray

In some examples the target may have information for how the page would be reloaded into the input tray/ For example, text may read “place this side up when reloading” or “place this edge at top of tray”. In other examples marks or diagrams may be included on the target to help a user orient the page during reloading of the page at step 552.

What is claimed is:

1. A printer, comprising;
a controller coupled to memory;
code stored in the memory, that when executed by the processor causes the printer to print an image of a first target onto media and to print an image of a second target onto the media after the media is re-loaded into the printer;
the first target having at least a first data scale and the second target having at least a first vernier scale, where a location of the at least first data scale and a location of the at least first vernier scale in the first and second targets respectively, cause the images of the two scales to be near each other on the media when printed on the same side of the media and rotated 180 degrees with respect to each other.

2. The printer of claim 1, further comprising:
the first target having at least a second data scale and the second target having at least a second vernier scale, where a location of the at least second data scale and a location of the at least second vernier scale in the first and second targets respectively, cause the images of the second two scales to be relatively close to each other on the media when printed on the same side of the media and rotated 180 degrees with respect to each other, and where the second scales are orthogonal with respect to the at least first scales.

3. The printer of claim 1 where the first target is identical to the second target.

4. The printer of claim 1, further comprising:
a center pattern located in the first and second targets.

5. The printer of claim 1, further comprising:
reloading orientation information located on the first target.

6. The printer of claim 1, further comprising:
code stored in the memory, that when executed by the processor causes the printer to prompt the user to reload the page into the printer after the page has been rotated 180 degrees.

7. The printer of claim 1, further comprising:
code stored in the memory, that when executed by the processor causes the printer to prompt the user to reload the page in a specific orientation into the input tray.

8. The printer of claim 1 where the first target and the second target are stored in the memory.

9. The printer of claim 1 where the first scales are X-axis scales.

10. The printer of claim 1 where the first target and the second target overlap when printed on the same side of the media and rotated 180 degrees with respect to each other.

11. A method of calibrating a printer, comprising:
printing an image of a first target on a first side of a sheet of media;
printing an image of a second target on the first side of the sheet of media after the media is rotated 180 degrees;
receiving offset information indicated from the two images of the targets printed on the same side of the media; and
calibrating the printer using the offset information.

12. The method of claim 11, where the first target is the same as the second target.

13. The method of claim 11, where the first target has at least one data scale in the X-axis and the second target has at least one vernier scale in the X-axis and where a position of the at least one data scale and a position of the at least one vernier scale in the first and second targets respectively cause the two scales to be near each other on the media.

14. The method of claim 13, where the first target has at least one Y-axis data scale and the second target having at least one Y-axis vernier scale, where a location of the at least one Y-axis data scale and a location of the at least one Y-axis vernier scale in the first and second targets respectively, cause the images of the two scales to be nears each other on the media.

15. The method of claim 11, where the printer prompts the user to reload the page into the printer after the page has been rotated 180 degrees.

16. The method of claim 11, where the printer prompts the user to reload the page in a specific orientation into the input tray.

17. The method of claim 11, where the first target has information that aids a user for the proper page orientation when reloading the page into the printer.
